(19) United States
(12) Patent Application Publication
(10) Pub. No.: US 2020/0326892 A1
(43) Pub. Date: Oct. 15, 2020

(54) METHODS FOR ENCRYPTING AND UPDATING VIRTUAL DISKS

(71) Applicant: Microsoft Technology Licensing, LLC, Redmond, WA (US)

(72) Inventor: Jonathan James CARUANA, Woodinville, WA (US)

(73) Assignee: Microsoft Technology Licensing, LLC, Redmond, WA (US)

(21) Appl. No.: 16/380,895

(22) Filed: Apr. 10, 2019

(51) Int. Cl. G06F 3/06; G06F 9/455; H04L 9/06

(52) U.S. Cl. CPC G06F 3/0664; H04L 9/0618; H04L 9/0643; G06F 9/45558

(57) ABSTRACT

A method for encrypting a virtual disk comprises generating a hash value for each page of a first version of the virtual disk. Each page is encrypted using a unique initialization vector (IV). Each unique IV and each generated hash value is then stored in a plaintext hash database that maps each unique IV for a page to a corresponding hash value. For a second, updated version of the virtual disk, a hash value is generated for each page of the second version. It is then determined whether each newly generated hash value is stored in the plaintext hash database. If a first generated hash value for a first page of the second version of the virtual disk is stored in the plaintext hash database, such first page is encrypted using a unique IV from the plaintext hash database that corresponds to the first generated hash value.

### BACKGROUND

Secure content, such as encrypted media, may be stored on virtual disks that may be distributed to a plurality of client computing devices. Periodically, the encrypted media may be updated with new and/or adjusted content, which may then be securely distributed to some or all of the client computing devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for encrypting a virtual disk comprises generating a hash value for each page of a first version of the virtual disk. Each page is encrypted using a unique initialization vector (IV). Each unique IV and each generated hash value is then stored in a plaintext hash database that maps each unique IV for a page to a corresponding hash value. For a second, updated version of the virtual disk, a hash value is generated for each page of the second version. It is then determined whether each newly generated hash value is stored in the plaintext hash database. If a first generated hash value for a first page of the second version of the virtual disk is stored in the plaintext hash database, such first page is encrypted using a unique IV from the plaintext hash database that corresponds to the first generated hash value.

### BRIEF DESCRIPTION OF THE DRAWINGS

FIG. 1 shows a schematic view of an example computing environment that includes client computing devices and a server computing device.

FIG. 2 shows an example method for encrypting a virtual disk.

FIG. 3 schematically shows databases comprising hash values and initialization vectors for virtual disks.

FIG. 4 shows an example method for disseminating an updated version of an encrypted virtual disk.

FIG. 5 schematically shows example update plans for encrypted virtual disks.

FIG. 6 shows an example method for updating an encrypted virtual disk.

FIG. 7 shows a schematic view of an example computing device.

### DETAILED DESCRIPTION

Encrypted, signed, read-only virtual disks may be used to store content files. By design, encrypted data is challenging to manipulate without being in possession of the associated encrypt key material or without significant disk input/output (I/O) bandwidth available to decrypt, edit, and re-encrypt the disk. For rich game content, the encrypted virtual disks may contain tens of gigabytes of data or more. While this format is good for maintaining content security, it may be deleterious for the efficient download of content updates over a network.

Current practices for updating content typically require the downloader to operate on the content in plaintext, thus requiring the key material for the content at the time of download. This may potentially open a vulnerability window during the update. Alternatively, updating content may occur by operating on the content in ciphertext. However, this may incur poor download efficiency proportionate to the granularity of the update. Portions of virtual disks may be edited, downloaded, and updated, rather than the entire virtual disk itself. For example, a virtual disk may be divided into regions (or chunks) or files. If any byte in the region or file is different in the updated disk, the entire region or file must be re-downloaded.

At the lowest granularity, this method of updating generates large download files and subsequently generates large disk images. These disk images may perpetually grow in size at each update if the older content is not modifiable. Thus, there is a need for means to efficiently update data on encrypted virtual disks, minimizing the size of the download package and size of distribution over streaming while simultaneously protecting the secrecy of the data during the update. Further, it is desirable that the updates take place without bloating the disk storage with unusable or redundant content from older versions of the virtual disks.

This detailed specification describes systems and methods for improved means to update secure content (e.g., encrypted media) stored on virtual disks. Updates may be applied selectively and/or partially. In other words, partial data within a file may be updated rather than a whole file. Specifically, content from an old disk image is re-used to generate a new, updated disk image. The granularity of the updates can then be at the page level instead of at the file or region level.

During the disk creation process, inputs (e.g., updated and re-used data) can be intentionally chosen so as to maximize the ability of the downloader to reuse encrypted data from an old disk image as-is in order to minimize both the size of the download package and the size of the disk footprint.

In general, most encryption/decryption schemes, regardless of algorithm, involve a secret key, an initialization vector (IV), and the plaintext data to encrypt (or cyphertext to decrypt). Selecting IVs is important in generating a virtual disk that's modifiable. Typically, virtual disks assign an IV value of 0 at the beginning and increment up, page by page, as the disk progresses. This ensures that if the same data is encrypted in two parts of the disk, the ciphertext will be different, otherwise the ciphertext would leak information about the disk contents.

This scheme works well if a disk is being modified in place, or when sending a disk as Read-only. However, if data is inserted into, or removed from, the updated disk, the disk indices and initialization vectors will shift, and thus the old and new disks won't match up correctly.

In examples herein, IVs are re-used from an old disk image in generating a new disk image. Once two encrypted virtual disk images have been created, each page is hashed. For each page in the new disk image, its hash is compared to all page hashes from the old disk. If a match is found, then that page is added to the update plan as an indication to copy the old page. If a match is not found, then the page is added as a download. Consecutive copy or download operations are merged together within the plan. In this way, only pages containing new or updated data need be downloaded and applied as an update. Pages containing data that is unchanged are preserved at the local disk.

The systems and methods disclosed herein may thus represent an improvement in the art of applying updates to encrypted virtual disks as the granularity of operation may be reduced to the order of individual indexable data sections (e.g., pages) rather than whole files or regions. Further, the methods disclosed herein explicitly use data about the old disk image to generate the new disk image instead of relying on consistent convention (e.g., file name hashing) to implicitly cause the data to match. Additionally, these methods allow for the creation of precomputed plans that a client can use to efficiently perform the update without requiring significant data from the new disk image.

As such, the efficiency of downloading updates to large pieces of content is improved while the security of that content is maintained. This results in minimized download size and minimized size on disk. The data remains encrypted throughout the update process. Further, developers have more freedom to insert new data without the fear of the files and virtual disks becoming bloated following updates.

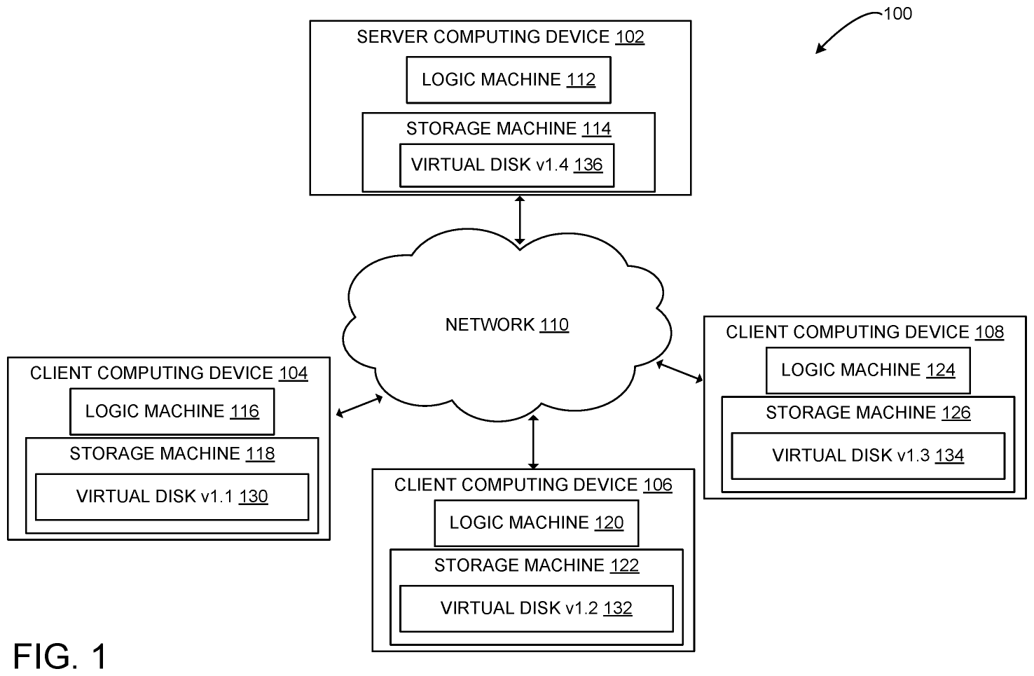

FIG. 1 illustrates an example computing environment 100 that includes a server computing device 102 configured to communicate with a plurality of client computing devices 104, 106, and 108 over one or more networks 110. Network(s) 110 may include any one or combination of multiple different types of networks, such as cellular networks, wireless networks, local area networks, and the Internet.

Server computing device 102 may comprise one or more discrete server computing devices operating in concert e.g., in a data center or cloud computing environment. In one example, server computing device 102 may include a plurality of server computing devices that operate in a cloud computing configuration operating in concert to implement the functions and processes of the server computing device 102 described herein. Server computing device 102 may include at least a logic machine 112 and a storage machine 114. Similarly, client computing device 104 includes at least a logic machine 116 and a storage machine 118, client computing device 106 includes at least a logic machine 120 and a storage machine 122, and client computing device 108 includes at least a logic machine 124 and a storage machine 126.

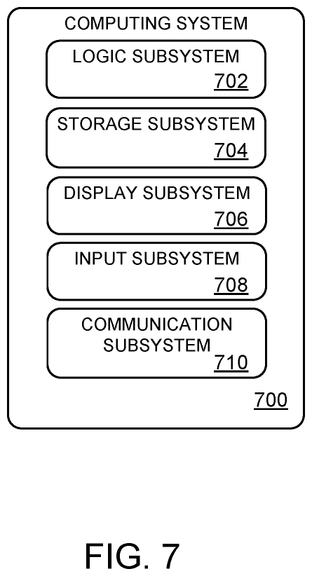

Each client computing device 104, 106, and 108 may include any combination of hardware and/or software resources configured to process data. Client computing devices 104, 106, and 108 may be implemented as any number of devices including, for example, a personal computer, a laptop computer, a cell phone, a tablet device, a personal digital assistant (PDA), etc. Additional features and attributes of example computing devices are provided herein with regard to FIG. 7.

Client computing devices 104, 106, and 108 may communicate with server computing device 102 over network 110 to provide and receive data and/or metadata. For instance, client computing devices 104, 106, and 108 may communicate with server computing device 102 to request and/or receive content, such as media data, applications, and/or metadata. Such content may be provided in the form of one or more virtual disks. The virtual disk platform may be considered a publicly-available image format specification that specifies a virtual hard disk encapsulated in a single file, capable of hosting native file systems while supporting standard disk and file operations.

Virtual disks may be generated at server computing device 102 or at another device and provided to server computing device 102 to distribute to one or more client computing devices, such as client computing devices 104, 106, and 108. The virtual disk may include one or a combination of media, data, application(s), software, etc. For instance, the virtual disk may include one or more video files, audio files, text files, and/or multimedia files to be provided over network 110 and presented on a client computing device. Alternatively, or in addition, the content provided over network 110 may be a virtual disk update to be distributed to client computing devices 104, 106, and 108.

As shown, each of client computing devices 104, 106, and 108 have a different build version of a virtual disk. Client computing device 104 includes virtual disk 1.1 (130) stored on storage machine 118, client computing device 106 includes virtual disk 1.2 (132) stored on storage machine 122, and client computing device 108 includes virtual disk 1.3 (134) stored on storage machine 118. Server computing device 102 includes an updated virtual disk 1.4 (136) stored on storage machine 114. Server computing device 102 may provide an indication to one or more of client computing devices 104, 106, and 108 that an updated version of the virtual disk is available, and may transfer all or part of virtual disk 1.4 (136) over network 110 in response to receiving a request from one or more of client computing devices 104, 106, and 108.

Further, each virtual disk may be an encrypted virtual disk, and thus may include encryption information that may indicate a type of encryption (e.g., encryption method) performed at the server computing device 102 or elsewhere to encrypt the plurality of data blocks that comprise the virtual disk, and may include information for decryption, such as a decryption key. Each client computing device may include one or more applications, executing on a logic machine that performs operations for processing the virtual disk, such as dividing, encrypting, compressing, and/or creating validation information for the virtual disk.

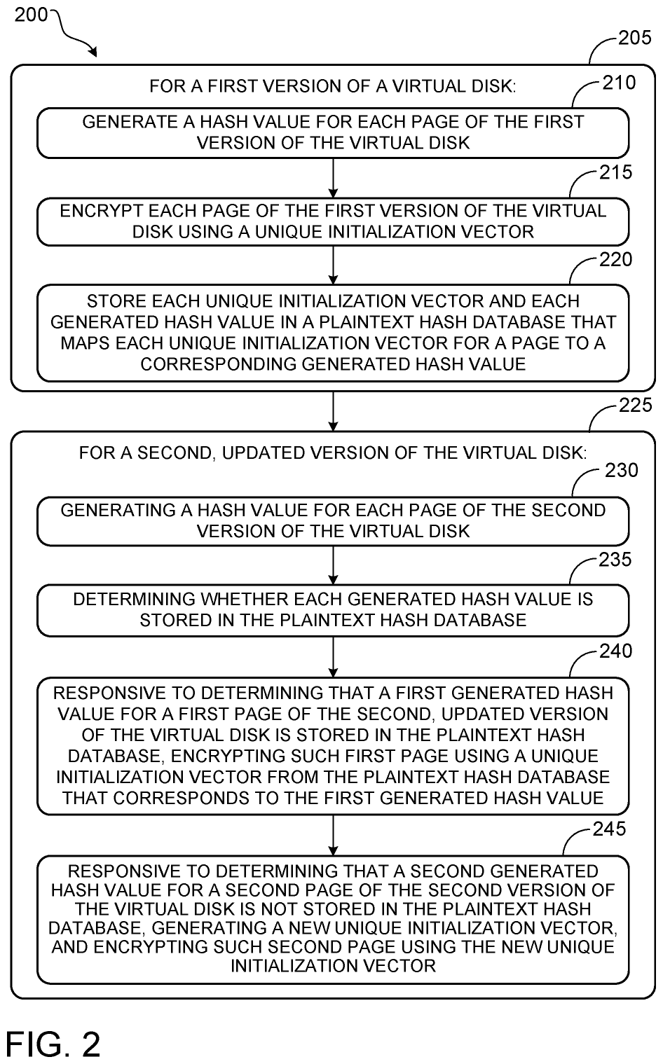

FIG. 2 shows an example method 200 for encrypting a virtual disk. Method 200 may be executed by one or more computing devices, such as server computing device 102. At 205 method 200 includes generating a first version of a virtual disk. At 210, method 200 includes generating a hash value for each page of the first version of the virtual disk. As described herein, a “page” may refer to any indexable section of data within the virtual disk. As one non-limiting example, a page may be a 4K indexable segment of data. The hash value may be generated for a plaintext page and/or an encrypted page. The hash value may be generated via any suitable hash function, such as HMAC-SHA1, HMAC-SHA256, HMAC-SHA3, etc. In some examples, the output of the hash function may be truncated to generate the hash value.

At 215, method 200 includes encrypting each page of the first version of the virtual disk using a unique initialization vector (IV). The initialization vector may include an arbitrary number that can be used along with a secret key for data encryption. The initialization vector may further include a content ID and region ID for the virtual disk.

For example, the first page of the virtual disk may be given an IV equal to 0. For each subsequent page, the IV may be incremented by 1, thus creating a linear sequence wherein the IV for the page is based on the offset of page from the beginning of the virtual disk.

At 220, method 200 includes storing each unique initialization vector and each generated hash in a plaintext hash database that maps each unique initialization vector for a page to a corresponding generated hash. The plaintext hash database may be considered as a chunk of metadata that maps the unencrypted plaintext pages to the IV chosen for that page via the generated hash value for the page. Hashes generated for encrypted pages may be stored in a hash tree, wherein each leaf of the hash tree includes a generated hash for a single page of the first version of the virtual disk.

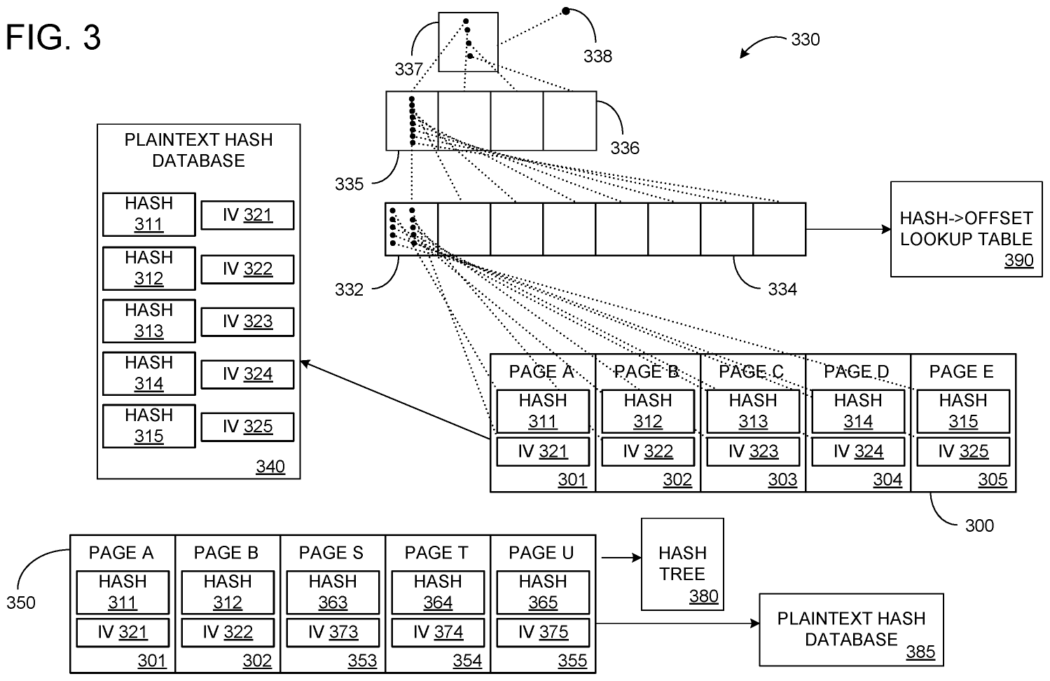

For example, FIG. 3 schematically shows an example virtual disk 300 including a plurality of pages of data. Five representative, consecutive pages are shown—page A 301, page B 302, page C 303, page D 304, and page E 305. Each page may be hashed to generate a hash value. For example, page A 301 has a hash value 311, page B 302 has a hash value 312, page C 303 has a hash value 313, page D 304 has a hash value 314, and page E 305 has a hash value 315. Each page is also encrypted based on an initialization vector. For example, page A 301 has an IV 321, page B 302 has an IV 322, page C 303 has an IV 323, page D 304 has an IV 324, and page E 305 has an IV 325.

The hash values and IVs for virtual disk 300 may be stored in a hash tree 330. As shown, hash values 311-315 and IVs 321-325 are stored as leaves in a first node 332 of a first branch 334 of hash tree 330. Each node of first branch 334 may be hashed and stored as leaves in a first node 335 of second branch 336. This hashing may continue, with each node of second branch 336 hashed and stored as leaves in third branch 337, etc. until one hash is left—e.g., root node 338. Root node 338 may effectively be used to represent the identity of virtual disk 300. Unencrypted hash values and IVs may be stored in an unencrypted plaintext hash database 340.

Returning to FIG. 2, at 225, method 200 includes instructions for encrypting a second, updated version of the virtual disk. During the package creation and encryption process for the updated version of the virtual disk, unchanged input data may be kept unchanged in the output. In other words, pages of the first version of the virtual disk that are unchanged in the second disk may be maintained. However, changed pages, inserted pages, and deleted pages may change the offset of the pages within he updated version of the virtual disk. As such, the previously assigned initialization vectors may become misaligned in the updated disk if they were assigned linearly in the first version of the virtual disk.

At 230, method 200 includes generating a hash for each page of the second version of the virtual disk. For example, FIG. 3 schematically shows virtual disk 350, which may be considered a second, updated version of virtual disk 300. Virtual disk 350 includes five representative, consecutive pages: page A 301, page B 302, page S 353, page T 354, and page U 355. Page A 301 and page B 302 are identical to the pages A 301 and B 302 within virtual disk 300, while page S 353, page T 354, and page U 355 may be newly inserted or updated pages. Accordingly, page A 301 retains hash value 311, page B 302 retains hash value 312. Page S 353 is assigned a hash value 363, page T 354 has a hash value 364, and page E 355 has a hash value 365.

At 235, method 200 includes determining whether each generated hash value is stored in the plaintext hash database. For example, hash values 311 and 312 are stored in plaintext hash database 340. At 240, method 200 includes, responsive to determining that a first generated hash for a first page of the second, updated version of the virtual disk is stored in the plaintext hash database, encrypting such first page using a unique initialization vector from the plaintext hash database that corresponds to the first generated hash. Accordingly, IV 321, correlating to hash value 311 is assigned to page A 301, and IV 322, correlating to hash value 312, is assigned to page B 302. In this way, the plaintext hash database is used to determine the assigned IV for a given page, and thus plaintext is used to determine the cyphertext for the given page.

At 245, method 200 includes, responsive to determining that a second generated hash for a second page of the second version of the virtual disk is not stored in the plaintext hash database, generating a new unique initialization vector; and encrypting such second page using the new unique initialization vector. For example, hash values 363, 364, and 365 are not stored in plaintext hash database 340. As such, new IVs are assigned to the correlating pages. IV 373 is assigned to page S 353, IV 374 is assigned to page T 354, and IV 375 is assigned to page U 355.

In some examples, a newly assigned unique IV may be based on an initialization vector for a page antecedent to the second page. As an example, IV 373 may be based on IV 322. In some examples, the new unique initialization vector may be based on an incrementation from the initialization vector for the page antecedent to the second page. For example, IV 373 may be equal to IV 322 plus one. This preserves the linearity of the original pages. While some discontinuities will be created in the overall sequence, original data is preserved and as much original sequence is preserved, thus minimizing the size of subsequently generated lookup tables.

In some examples, the new unique initialization vector may be based on an offset of the second page within the second, updated version of the virtual disk. For example, the IV may be based on a hash of a filename and the offset of the page within the file. This preserves sequentialness of the newly generated IVs, and supports a compact offset+IV lookup table.

Additionally or alternatively, the new unique initialization vectors may be generated randomly, pseudo-randomly, or by any other suitable means. For example, if an IV is not found in the plaintext hash database, a new IV may be generated at random and added to the plaintext hash database. This approach generates high randomness, such that the IV is hard to trace back to the plaintext, but IVs for consecutive pages may be non-sequential.

In other examples, the new unique IV may be derived directly from the plaintext, for example using a function such as Truncate(HMACSHA(PrivacyKey, 4KPlaintext)). A PrivacyKey would be created and maintained per-content. The HMAC helps minimize the plaintext data that leaks from this process. Such a leak may be fairly minor; the hash tree will contain a portion of the HMACSHA in plaintext. Without knowing the PrivacyKey it would be infeasible for an attacker to recover any of the plaintext itself. However, an attacker could determine that two pages of a file contain the same data. By using a per-content PrivacyKey, an attacker could not do any correlation across different content. This represents an improvement over using a global PrivacyKey, whereby a malicious developer could attempt to use the encryption process as an oracle to guess and check to find out if another game contained specific content.

As another example, randomly chosen IVs may be persisted in a database. The database lookup input may be a function such as HMACSHA(PrivacyKey, 4KPlaintext) and the output would be the IV. When the lookup fails, a random IV would be generated and added to the database. One advantage of this approach is that existing virtual disks can be imported. An existing virtual disk would be decrypted and each page of the virtual disk would have its existing IV added to a database. Similarly, if the database is lost or corrupted it can be recovered using this import process. HMACSHA may be used to minimize the information about the plaintext that leaks when the database is stored outside of the computer performing the encryption. Additionally or alternatively, an encryption function, such as Advanced Encryption Standard (AES) may be used to encrypt the database.

When IVs have been assigned to each page of the updated disk, an updated hash tree 380 may be generated, and an updated plaintext hash database 385 may also be generated for the second, updated version of the virtual disk, the updated plaintext hash database including each unique initialization vector reused from the first version of the virtual disk, each new unique initialization vector, each generated hash, and each offset for each page of the second, updated version of the virtual disk.

Once the updated version of the encrypted virtual disk has been hashed, and IVs assigned to each page, an update plan may be generated indicating how to disseminate the updated version of the encrypted virtual disk from the server computing devices to client computing devices. Each client computing device may have differing versions of the virtual disk, as shown in FIG. 1. Some virtual disks are frequently updated, and thus client computing devices storing older versions may be required to upgrade to an intermediate version of the virtual disk before downloading the newest version. As such, each update plan may be specific for each client computing device. This may be based on data indicating which build of the virtual disk is stored at each client computing device. Such an indication may be stored at the server, or provided to the server by the client computing device. Such update plans may be generated when the updated version of the encrypted virtual disk is generated, rather than on-demand. By developing the update plan on the server side, the client computing device is able to quickly download the update plan and initiate downloading the updated version of the encrypted virtual disk, rather than downloading the full hash database and then generating a plan locally.

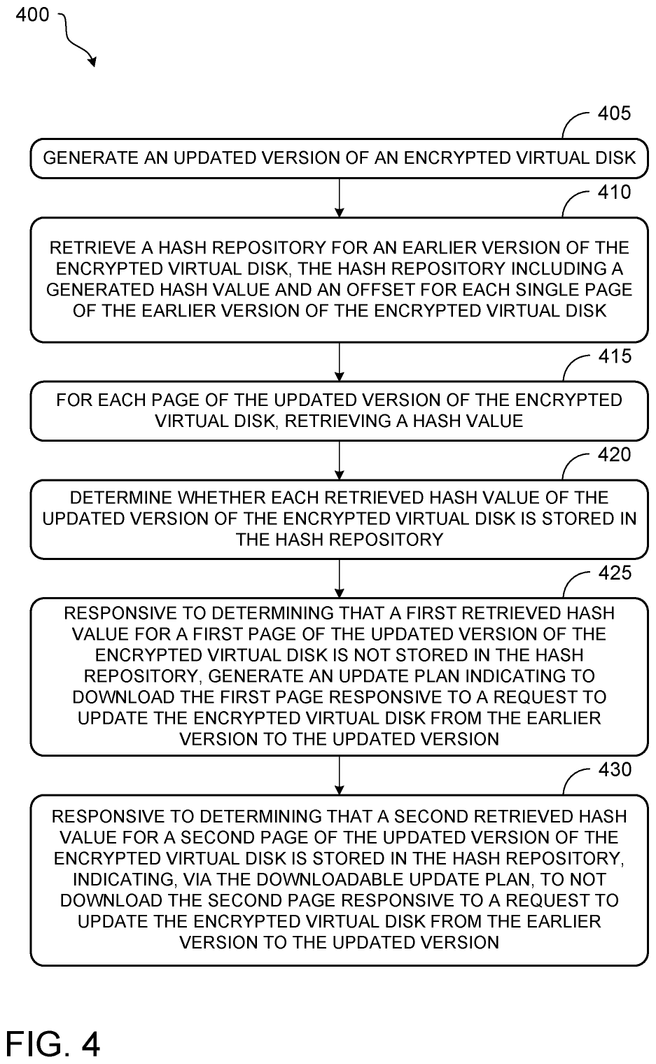

FIG. 4 shows a method 400 for disseminating an updated version of an encrypted virtual disk. Method 400 may be executed at a server computing device, such as server computing device 102. At 405, method 400 includes generating an updated version of the encrypted virtual disk, such as updated virtual disk 350. At 410, method 400 includes retrieving a hash repository for an earlier version of the encrypted virtual disk, the hash repository including a generated hash value and an offset for a single page of the earlier version of the encrypted virtual disk. As used herein, the hash repository may include a plaintext hash database and/or a hash tree or any other suitable listing of page hashes, IVs, and offsets for the earlier version of the encrypted virtual disk. For example, plaintext hash database 340 may be retrieved for a client computing device upgrading from virtual disk 300.

At 415, method 400 includes, for each page of the updated version of the encrypted virtual disk, retrieving a hash value. For example, the hash values may be retrieved from a plaintext hash database and/or a hash tree. In some examples, the hash values may be generated anew. In this way, the leaf hash nodes of both the updated version and earlier version of the virtual disk may be collected. In some examples, method 400 may include, for the earlier version of the encrypted virtual disk, a lookup table mapping generated hash values and initialization vectors to page offsets may be generated for each page of the encrypted virtual disk, and a page offset retrieved for each generated hash value.

For example, the primary hash tree allows for the lookup of an offset to get a hash. The tree may be inverted, allowing for the lookup of a hash to get the offset, where the offset is a location within the virtual disk relative to the beginning of disk image. For example, hash tree 334 may be inverted to generate hash->offset lookup table 390.

At 420, method 400 includes determining whether each retrieved hash value of the updated version of the encrypted virtual disk is stored in the hash repository. For example, for each page of the updated version of the encrypted virtual disk, the respective hash may be retrieved and looked up in the hash->offset lookup table for the earlier version of the encrypted virtual disk. If the hash is found in the lookup table, this indicates that the page in the updated version matches a page in the earlier version, and allows for the retrieval of the offset (e.g., location) for that page within the earlier version of the encrypted virtual disk.

At 425, method 400 includes, responsive to determining that a first retrieved hash value for a first page of the updated version of the encrypted virtual disk is not stored in the hash repository, generating an update plan indicating to download the first page responsive to a request to update the encrypted virtual disk from the earlier version to the updated version. In other words, the update plan will indicate to download each page of the updated version of the encrypted virtual disk that is not found in the earlier version of the encrypted virtual disk.

At 430, method 400 includes, responsive to determining that a second retrieved hash value for a second page of the updated version of the encrypted virtual disk is stored in the hash repository, indicating, via the downloadable update plan, to not download the second page responsive to a request to update the encrypted virtual disk from the earlier version to the updated version. In other words, the update plan will indicate to conserve each page of the earlier version of the encrypted virtual disk that is found in the updated version of the encrypted virtual disk. The client computing device, when building the local copy of the updated version of the encrypted virtual disk will be instructed to download or obtain conserved pages from the earlier version of the encrypted virtual disk, rather than from the server computing device.

The size of the download plan may be reduced by bundling ranges of consecutive pages that are to be downloaded from the server computing device or conserved from the earlier version of the virtual disk stored locally. Then, rather than listing every page individually in the update plan, a list of starting offsets and lengths may be listed in the update plan. This aids in generating a compact list of instructions for the client computing device to follow to generate the updated version.

For example, responsive to determining that generated hash values for a range of sequential pages within the updated version of the encrypted virtual disk are stored in the hash repository, the process can be optimized once a page is found in the earlier version. For example, when a corresponding page is found, the earlier version and updated version may be scanned linearly until a mismatch is found (e.g., a hash from the updated version is not found in the earlier version). Similarly, when a corresponding page is not found, the earlier version and updated version may be scanned linearly until a match is found between the two versions.

In this way, the downloadable update plan may include alternate page ranges to download from the server and to download from the earlier version of the encrypted virtual disk. However, each download request incurs a certain overhead cost for the client and server. As such, it may not be efficient to preserve a single page in the middle of two ranges of pages to be downloaded. As such, the update plan may indicate to download a page span even if it is found in the earlier version unless the page span of matching pages is greater than a threshold.

In some examples, generated hash values for a page may be looked up in hash repositories for both the updated version of the encrypted virtual disk and the earlier version of the encrypted virtual disk. The downloadable update plan may then indicate to download at most one copy of a repeated page.

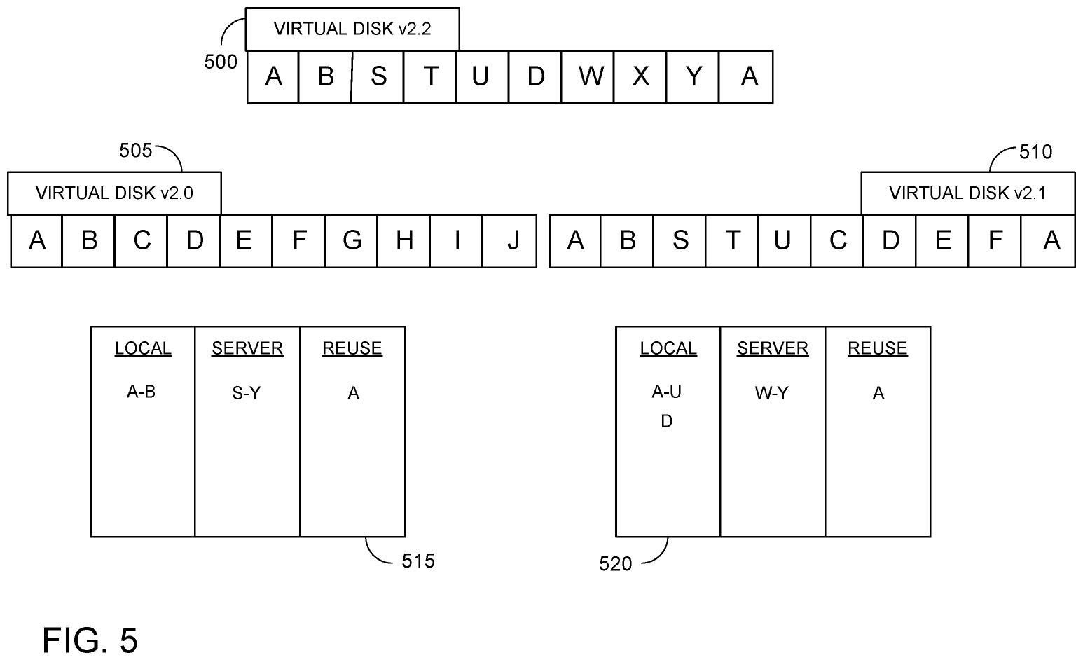

As an example, FIG. 5 schematically shows example update plans for encrypted virtual disks. Virtual disk v2.2 (500) represents an example updated encrypted virtual disk, comprising ten data pages. Virtual disk v2.0 (505) represents a first example updated encrypted virtual disk, also comprising ten data pages. Virtual disk v.2.1 (510) represents a second example updated encrypted virtual disk. Virtual disk v. 2.1 (510) may have previously undergone an update from v 2.0.

To update virtual disk v2.0 (505) to virtual disk v2.2 (500), an update plan 515 is generated as described with regard to FIG. 4. Pages of virtual disk v2.2 (500) are compared to pages of virtual disk v2.0 (500) via plaintext hash databases and offset tables. Update plan 515 indicates that the range of pages A and B may be conserved locally. Page range S-Y may be downloaded from the server. Although page D is available locally, the page is downloaded to conserve the range S-Y. Page A may be conserved and duplicated.

Pages of virtual disk v2.1 (510) are compared to pages of virtual disk v2.0 (500) via hash repositories and offset tables as described. Update plan 520 indicates that the range of pages A-U, as well as page D may be conserved locally. Page range W-Y may be downloaded from the server. Page A may be conserved and duplicated.

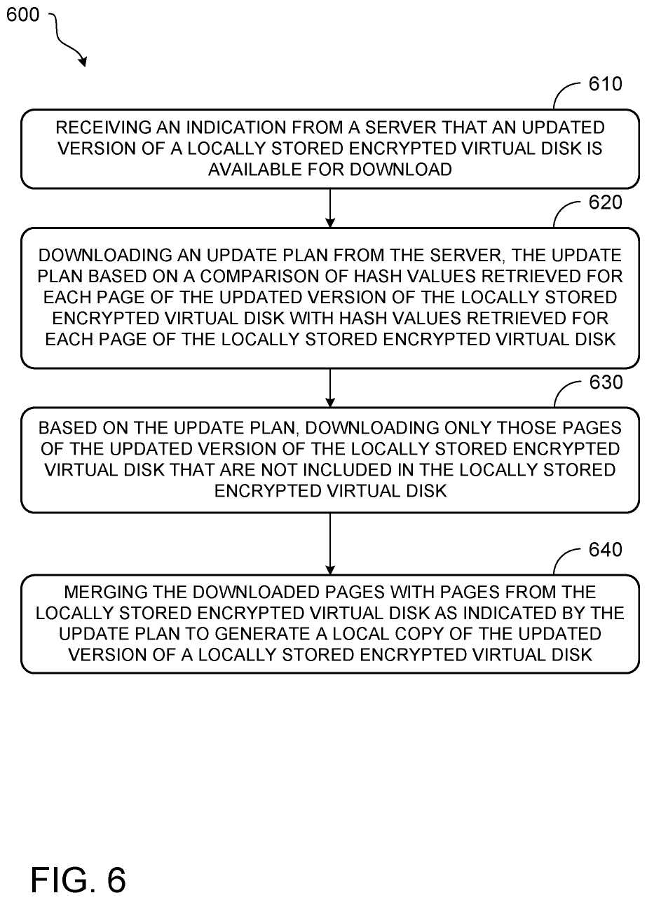

FIG. 6 shows an example method 600 for updating an encrypted virtual disk. Method 600 may be executed at a client computing device, such as client computing devices 104, 106, and 108. At 610, method 600 includes receiving an indication from a server that an updated version of a locally stored encrypted virtual disk is available for download. For example, a server computing device may issue an indication to all client computing devices storing an earlier version of the encrypted virtual disk.

At 620, method 600 includes downloading an update plan from the server, the update plan based on a comparison of hash values retrieved for each page of the updated version of the locally stored encrypted virtual disk with hash values retrieved for each page of the locally stored encrypted virtual disk. For example, update plans 515 and 520 may be downloaded, and the update plan may be generated at the server according to method 400. In some examples, the update plan may be accompanied by a staging area, the staging area providing the framework for local assembly of the updated version of a locally stored encrypted virtual disk.

At 630, method 600 includes, based on the update plan, downloading only those pages of the updated version of the locally stored encrypted virtual disk that are not included in the locally stored encrypted virtual disk. The downloaded pages may be positioned in the staging area based on the offsets indicated by the update plan.

At 640, method 600 includes merging the downloaded pages with pages derived from the locally stored encrypted virtual disk as indicated by the update plan to generate a local copy of the updated version of the locally stored encrypted virtual disk. For example, the pages derived from the locally stored encrypted virtual disk may be ported to the staging area based on offsets indicated by the update plan.

In some examples, if a page is repeated in the updated version of the locally stored encrypted virtual disk, a single version will be placed at each offset, be it a newly downloaded page or a previously locally stored page. Following assembly of the updated version, unused data from the earlier version may be moved or deleted.

The technical effect of implementing the described methods and systems is that updates to encrypted virtual disks may be applied at a page granularity. If any byte within a data page is different, then that page will be redownloaded. If the page is unchanged, it will be conserved from a local copy. There are numerous benefits of page granularity. For example, this eliminates efficiency differences between updating many small files and a few large compressed files, such as pack files and/or ZIP files. As game developers and established engines prefer larger pack files this significantly reduces update download sizes as compared to downloading entire files that have minute changes.

Further, encrypted virtual disks no longer need to keep unused and obsolete data in their layout to avoid changing a large pack file. This will decrease the size of disks and help prevent file bloat.

Additionally, because any pages can be changed, developers no longer need to engineer specifically for content updates. Additionally, end users are no longer hurt when game developers poorly engineer for content updates.

Changes within a file, including deletions, insertions, and modifications may be selectively applied, rather than simply analyzing whether the file has changed or not.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices.

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 implemented to perform a particular function. In some cases, a module, program, or engine may be instantiated via logic machine 702 executing instructions held by storage machine 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

In one example, a method for encrypting a virtual disk comprises, for a first version of the virtual disk: generating a hash value for each page of the first version of the virtual disk; encrypting each page of the first version of the virtual disk using a unique initialization vector; and storing each unique initialization vector and each generated hash in a plaintext hash database that maps each unique initialization vector for a page to a corresponding generated hash value; and for a second, updated version of the virtual disk: generating a hash value for each page of the second version of the virtual disk; determining whether each generated hash value is stored in the plaintext hash database; and responsive to determining that a first generated hash value for a first page of the second, updated version of the virtual disk is stored in the plaintext hash database, encrypting such first page using a unique initialization vector from the plaintext hash database that corresponds to the first generated hash value. In such an example, or any other example, the method additionally or alternatively comprises for the second, updated version of the virtual disk: responsive to determining that a second generated hash value for a second page of the second version of the virtual disk is not stored in the plaintext hash database, generating a new unique initialization vector; and encrypting such second page using the new unique initialization vector. In any of the preceding examples, or any other example, the new unique initialization vector is additionally or alternatively generated randomly. In any of the preceding examples, or any other example, the new unique initialization vector is additionally or alternatively based on an initialization vector for a page antecedent to the second page. In any of the preceding examples, or any other example, the new unique initialization vector is additionally or alternatively based on an incrementation from the initialization vector for the page antecedent to the second page. In any of the preceding examples, or any other example, the new unique initialization vector is additionally or alternatively based on an offset of the second page within the second, updated version of the virtual disk. In any of the preceding examples, or any other example, the method additionally or alternatively comprises generating an updated plaintext hash database for the second, updated version of the virtual disk, the updated plaintext hash database including: each unique initialization vector reused from the first version of the virtual disk; each new unique initialization vector; and each generated hash value for each page of the second, updated version of the virtual disk.

In another example, a method for disseminating an updated version of an encrypted virtual disk, comprises generating an updated version of the encrypted virtual disk; retrieving a hash repository for an earlier version of the encrypted virtual disk, the hash repository including a generated hash value and an offset for each single page of the earlier version of the encrypted virtual disk; for each page of the updated version of the encrypted virtual disk, retrieving a hash value; determining whether each retrieved hash value of the updated version of the encrypted virtual disk is stored in the hash repository; responsive to determining that a first retrieved hash value for a first page of the updated version of the encrypted virtual disk is not stored in the hash repository, generating an update plan indicating to download the first page responsive to a request to update the encrypted virtual disk from the earlier version to the updated version; and responsive to determining that a second retrieved hash value for a second page of the updated version of the encrypted virtual disk is stored in the hash repository, indicating, via the downloadable update plan, to not download the second page responsive to a request to update the encrypted virtual disk from the earlier version to the updated version. In such an example, or any other example, the hash repository is additionally or alternatively a plaintext hash database that includes plaintext hash values for each page of the earlier version of the encrypted virtual disk. In any of the preceding examples, or any other example, the hash repository is additionally or alternatively a hash tree that includes ciphertext hash values for each page of the earlier version of the encrypted virtual disk. In any of the preceding examples, or any other example, the method additionally or alternatively comprises, responsive to determining that retrieved hash values for a range of sequential pages within the updated version of the encrypted virtual disk are stored in the hash repository, indicating, via the downloadable update plan, not to download the range of pages. In any of the preceding examples, or any other example, the method additionally or alternatively comprises responsive to determining that retrieved hash values for a range of sequential pages within the updated version of the encrypted virtual disk are not stored in the hash repository, indicating, via the downloadable update plan, to download the range of pages. In any of the preceding examples, or any other example, the method additionally or alternatively comprises indicating to download a page span having generated hash values stored in the hash repository responsive to determining that the page span is less than a threshold. In any of the preceding examples, or any other example, the method additionally or alternatively comprises looking up generated hash values for a page in hash repositories for both the updated version of the encrypted virtual disk and the earlier version of the encrypted virtual disk; and assigning a single unique initialization vector to all repeated copies of the page. In any of the preceding examples, or any other example, the method additionally or alternatively comprises indicating, via the downloadable update plan, to download at most one copy of a repeated page.

In yet another example, a method for updating an encrypted virtual disk comprises receiving an indication from a server that an updated version of a locally stored encrypted virtual disk is available for download; downloading an update plan from the server, the update plan based on a comparison of hash values retrieved for each page of the updated version of the locally stored encrypted virtual disk with hash values retrieved for each page of the locally stored encrypted virtual disk; based on the update plan, downloading only those pages of the updated version of the locally stored encrypted virtual disk that are not included in the locally stored encrypted virtual disk; and merge the downloaded pages with pages derived from the locally stored encrypted virtual disk as indicated by the update plan to generate a local copy of the updated version of the locally stored encrypted virtual disk. In such an example, or any other example, the update plan additionally or alternatively indicates ranges of pages to download. In any of the preceding examples, or any other example, the update plan additionally or alternatively indicates to download page spans included in the locally stored encrypted virtual disk responsive to the page spans being less than a threshold. In any of the preceding examples, or any other example, pages repeated in the updated version of a locally stored encrypted virtual disk are additionally or alternatively placed within the updated version once and then copied based on offsets indicated by the update plan. In any of the preceding examples, or any other example, unused data from the locally stored encrypted virtual disk is additionally or alternatively deleted following assembly of the updated version of the locally stored encrypted virtual disk.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for encrypting a virtual disk, comprising:
for a first version of the virtual disk:
generating a hash value for each page of the first version of the virtual disk;
encrypting each page of the first version of the virtual disk using a unique initialization vector; and
storing each unique initialization vector and each generated hash in a plaintext hash database that maps each unique initialization vector for a page to a corresponding generated hash value; and
for a second, updated version of the virtual disk:
generating a hash value for each page of the second version of the virtual disk;
determining whether each generated hash value is stored in the plaintext hash database; and
responsive to determining that a first generated hash value for a first page of the second, updated version of the virtual disk is stored in the plaintext hash database, encrypting such first page using a unique initialization vector from the plaintext hash database that corresponds to the first generated hash value.

2. The method of claim 1, further comprising:
for the second, updated version of the virtual disk:
responsive to determining that a second generated hash value for a second page of the second version of the virtual disk is not stored in the plaintext hash database, generating a new unique initialization vector; and
encrypting such second page using the new unique initialization vector.

3. The method of claim 2, wherein the new unique initialization vector is generated randomly.

4. The method of claim 2, wherein the new unique initialization vector is based on an initialization vector for a page antecedent to the second page.

5. The method of claim 4, wherein the new unique initialization vector is based on an incrementation from the initialization vector for the page antecedent to the second page.

6. The method of claim 2, wherein the new unique initialization vector is based on an offset of the second page within the second, updated version of the virtual disk.

7. The method of claim 2, further comprising:
generating an updated plaintext hash database for the second, updated version of the virtual disk, the updated plaintext hash database including:
each unique initialization vector reused from the first version of the virtual disk;
each new unique initialization vector; and
each generated hash value for each page of the second, updated version of the virtual disk.

8. A method for disseminating an updated version of an encrypted virtual disk, comprising:
generating an updated version of the encrypted virtual disk;
retrieving a hash repository for an earlier version of the encrypted virtual disk, the hash repository including a generated hash value and an offset for each single page of the earlier version of the encrypted virtual disk;
for each page of the updated version of the encrypted virtual disk, retrieving a hash value;
determining whether each retrieved hash value of the updated version of the encrypted virtual disk is stored in the hash repository;
responsive to determining that a first retrieved hash value for a first page of the updated version of the encrypted virtual disk is not stored in the hash repository, generating an update plan indicating to download the first page responsive to a request to update the encrypted virtual disk from the earlier version to the updated version; and
responsive to determining that a second retrieved hash value for a second page of the updated version of the encrypted virtual disk is stored in the hash repository, indicating, via the downloadable update plan, to not download the second page responsive to a request to update the encrypted virtual disk from the earlier version to the updated version.

9. The method of claim 8, wherein the hash repository is a plaintext hash database that includes plaintext hash values for each page of the earlier version of the encrypted virtual disk.

10. The method of claim 8, wherein the hash repository is a hash tree that includes ciphertext hash values for each page of the earlier version of the encrypted virtual disk.

11. The method of claim 8, further comprising:
responsive to determining that retrieved hash values for a range of sequential pages within the updated version of the encrypted virtual disk are stored in the hash repository, indicating, via the downloadable update plan, not to download the range of pages.

12. The method of claim 11, further comprising:
responsive to determining that retrieved hash values for a range of sequential pages within the updated version of the encrypted virtual disk are not stored in the hash repository, indicating, via the downloadable update plan, to download the range of pages.

13. The method of claim 12, further comprising:
indicating to download a page span having generated hash values stored in the hash repository responsive to determining that the page span is less than a threshold.

14. The method of claim 8, further comprising:
looking up generated hash values for a page in hash repositories for both the updated version of the encrypted virtual disk and the earlier version of the encrypted virtual disk; and
assigning a single unique initialization vector to all repeated copies of the page.

15. The method of claim 14, further comprising:
indicating, via the downloadable update plan, to download at most one copy of a repeated page.

16. A method for updating an encrypted virtual disk, comprising:
receiving an indication from a server that an updated version of a locally stored encrypted virtual disk is available for download;
downloading an update plan from the server, the update plan based on a comparison of hash values retrieved for each page of the updated version of the locally stored encrypted virtual disk with hash values retrieved for each page of the locally stored encrypted virtual disk;
based on the update plan, downloading only those pages of the updated version of the locally stored encrypted virtual disk that are not included in the locally stored encrypted virtual disk; and
merge the downloaded pages with pages derived from the locally stored encrypted virtual disk as indicated by the update plan to generate a local copy of the updated version of the locally stored encrypted virtual disk.

17. The method of claim 16, wherein the update plan indicates ranges of pages to download.

18. The method of claim 16, wherein the update plan indicates to download page spans included in the locally stored encrypted virtual disk responsive to the page spans being less than a threshold.

19. The method of claim 16, wherein pages repeated in the updated version of a locally stored encrypted virtual disk are placed within the updated version once and then copied based on offsets indicated by the update plan.

20. The method of claim 16, wherein unused data from the locally stored encrypted virtual disk is deleted following assembly of the updated version of the locally stored encrypted virtual disk.
